(19) United States
(12) Patent Application Publication
(10) Pub. No.: US 2003/0217655 A1
(43) Pub. Date: Nov. 27, 2003

(54) Doctor blade system and method

(75) Inventors: Kurt Johann Oegerli, Cornelius, NC (US); Job Markas Shores, Faith, NC (US)

Correspondence Address: MATTHEW R. JENKINS, ESQ., 2310 FAR HILLS BUILDING, DAYTON, OH, 45419, US

(73) Assignee: Max Daetwyler Corp

(21) Appl. No.: 10/153,123

(22) Filed: May 22, 2002

(51) Int. Cl. B41F 9/10; B41F 31/04

(52) U.S. Cl. 101/169; 101/350.6

(57) ABSTRACT

A system and method for sealing a doctor blade is shown. The doctor blade has a non-planar area which facilitates providing at least one substantially continuous contact on one or both sides of the doctor blade to seal the doctor blade when it is situated in a blade holder.

### BACKGROUND OF THE INVENTION

1. Field of the Invention

This invention relates to a doctor blade assembly and, more particularly, to a self-sealing doctor blade having a portion which is non-planar in cross-section to provide at least one of continuous contact or pressure point when the blade is situated in a blade holder.

2. Description of Prior Art

Doctor blades are extensively used in rotary-printing units or presses, especially flexo-graphic units, for applying ink, lacquer, adhesive or the like to a rotating roll or cylinder rotatably mounted in the printing press. In a flexo-graphic or gravure-printing unit, for example, a doctor blade, such as a chamfered doctor blade, serves to ink the screen roller, that is, fill the cells or recesses of the roller with printing ink. The inking of the cylinder is essential for the printing result. It is of particular importance that the cylinder is uniformly inked which means that the distance between the roller and the doctor blade have to be accurately set. As a result, the chamfered doctor blade usually is clamped in a blade holder in the printing press, and it has to exhibit good flexural and torsional rigidity.

In a typical arrangement, an outer surface of the cylinder passes through an ink chamber defined by the blade holder and the doctor blades and picks up ink for printing. The ink is metered by means of the doctor blades which are held by the blade holder, with the free ends of the doctor blades being in contact or engagement with the outer surface of the cylinder. The doctor blades are clamped to the blade holder with suitable jaws. However, the housing is typically made of metal so that the seal between the doctor blade and the metal housing is not good, and ink tends to migrate between the doctor blade and the housing, making it difficult to clean and it causes ink to leak through the blade holder, among other things. In some instances, in order to prevent migration of the ink past the doctor blades, O-ring seals are provided in recesses of the chamber housing in contact with the doctor blades.

Over time, the doctor blades and seals become caked with ink and/or wear out. As a result, the doctor blades and 0-ring seals become ineffective for the purpose for which they are intended. In the past, some applications have provided a coating or tape on the doctor blade to provide a seal to prevent undesired migration of ink. U.S. Pat. Nos. 2,837,024; 2,313,830; 5,524,540; and Japanese Patent Publication 56-101853 all disclose approaches to sealing the doctor blade by applying a coating or seal tape directly to the doctor blade. One of the drawbacks of the approaches of the past is cost. The coatings or tape had to be applied to the doctor blades and the cost of these components was sometimes prohibitive.

What is needed, therefore, is a system and method for sealing a doctor blade which facilitates avoiding the problems of the past.

### SUMMARY OF THE INVENTION

Accordingly, it is a primary object of the present invention to provide a doctor blade having at least one substantially continuous pressure contact integrally formed in the blade to facilitate sealing the blade when it is situated in a blade holder.

It is another object of the present invention to provide a doctor blade having an integral non-planar area which facilitates providing at least one continuous contact along a width of the doctor blade.

Another object of the invention is to provide a system and method for sealing a doctor blade in a blade holder.

Yet another object of the invention is to provide a doctor blade having a non-planar area which facilitates providing a plurality of pressure points on both sides of the doctor blade to facilitate sealing both sides of the doctor blade when it is mounted in a blade holder.

Still another object of the present invention is to provide a printing press having the aforementioned doctor blade in which the blade prevents migration of ink past the blade holder.

In still another object of the invention, a doctor blade is provided having a predetermined cross-sectional shape which when placed in a blade holder, provides a plurality of sealing contacts for sealing the doctor blade in the blade holder.

Still another object of the invention is to provide a doctor blade having a generally V-shaped or U-shaped cross-section that provides a continuous point contact for sealing a side of the doctor blade for sealing the doctor blade when it is situated in a blade holder.

Still another object of the invention is to provide a doctor blade which may be used in either a single blade or multi-blade environment.

In one aspect this invention comprises a doctor blade comprising a blade member, the blade member comprising a substantially continuous pressure contact integral with the blade member to provide an ink seal when the blade is situated in a blade holder.

In yet another aspect this invention comprises a doctor blade comprising a blade member having a first side, a second side, and a non-planar area, and the non-planer area defining at least one contact on the first side so that when the doctor blade is situated in a blade holder in a press, the at least one contact is integral with the blade member and is in substantially continuous pressure engagement with the blade holder to facilitate preventing ink from leaking past at least one of the first side or second side of the blade holder.

In still another aspect this invention comprises a doctor blade assembly comprising a blade holder for holding a doctor blade, at least one doctor blade is situated in the blade holder, the at least one blade comprising a blade member having a first side, a second side, and a non-planar area; and the non-planar area defining at least one contact on the first side so that when the doctor blade is situated in a blade holder in a press, the at least one contact is in substantially continuous pressure engagement with the blade holder to facilitate preventing ink from leaking past at least one of the first side or second side of the blade holder.

In yet another aspect this invention comprises a doctor blade comprising a blade member comprising an engaging edge for engaging a rotating cylinder and a second edge for receipt in a blade holder, a formed area between the first edge and the second edge and the formed area providing a plurality of continuous pressure contacts between the blade member and the blade holder.

These and other objects and advantages of the invention will be apparent from the following description, the appended claims, and the accompanying drawings.

### BRIEF DESCRIPTION OF ACCOMPANYING DRAWING

FIG. 1 is a fragmentary sectional view showing a cylinder or roll in operative relationship with a plurality of doctor blades which are mounted in a blade holder;

FIG. 2 is a fragmentary sectional view showing details of the blade and blade holder;

FIG. 3 is fragmentary sectional view, taken along the line 3-3 in FIG. 2, showing a continuous contact point on a side of the doctor blade shown in FIG. 2;

FIG. 4 is a fragmentary sectional view showing another continuous contact point, taken along the line 4-4 in FIG. 2;

FIG. 5 is a fragmentary sectional view, taken along the line 5-5 in FIG. 2, showing a continuous contact point between the blade and blade holder;

FIG. 6 is a fragmented sectional view showing details of the doctor blade;

FIG. 7A illustrates a plan view of another embodiment of the invention showing a non-linear continuous contact edge or point;

FIG. 7B is a fragmentary sectional view, taken along the line 7B-7B in FIG. 7A;

FIG. 7C is a fragmentary sectional view, taken along the line 7C-7C in FIG. 7A;

FIG. 8A illustrates another embodiment of the inventions showing another non-linear continuous contact edge or point;

FIG. 8B is a fragmentary sectional view, taken along the line 8B-8B in FIG. 8A;

FIG. 8C is a fragmentary sectional view, taken along the line 8C-8C in FIG. 8A;

FIG. 9A illustrates still another embodiment of the inventions showing a non-linear continuous contact edge or point;

FIG. 9B is a fragmentary sectional view, taken along the line 9B-9B in FIG. 9A; and

FIG. 9C is a fragmentary sectional view, taken along the line 9C-9C in FIG. 9A.

### DETAILED DESCRIPTION OF PREFERRED EMBODIMENT

Referring now to FIG. 1, a printing system 10 comprising a printing press 12 which rotatably supports a roll or cylinder 14, such as an anilox roll, gravure cylinder or the like, in operative relationship with a doctor blade assembly 16. The doctor blade assembly 16 comprises a bottom 18, first wall 22 and second wall 24 which cooperate to define a well area 26 for receiving ink, lacquer, adhesive or other fluid to be applied to the roll 14. As illustrated in FIG. 1, a surface 14a of cylinder 14 is in operative engagement with the fluid 27 so that the ink may be applied to the surface 14a in a manner conventionally known. In some applications, for example, the surface 14a may have a pattern of cells or cavities (not shown) for receiving ink to print a pattern. It should be understood that the printing press 12 may be a flexographic printing system, gravure printing system, lithographic printing system that requires the application of fluid onto a cylinder.

The blade holder 16 further comprises a first jaw member 28 and a second member 29 which are secured to first wall 22 and second wall 24, respectively, with suitable nuts 30 and 32, as illustrated. The jaw members 28 and 29 clamp and hold a first blade 34 and second blade 35 to the blade holder 16, as best illustrated in FIG. 1. It should be appreciated that blade 35 is the same as blade 34. For ease of illustration, blade 34 will be described, but it should be understood that like components and features of blade 35 have the same part number, except that the number 35 replaces the number 34. For example, engaging edge 35c of blade 35 corresponds to engaging edge 34c of blade 34.

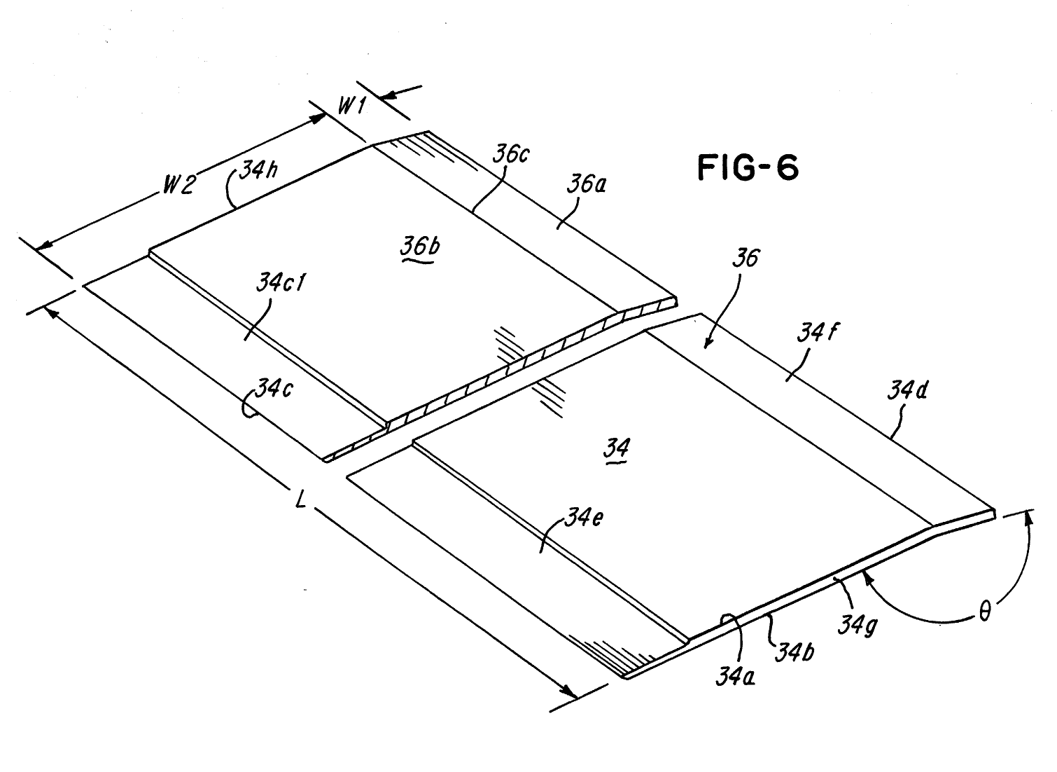

As illustrated in FIG. 6, blade 34 comprises a first side 34a, a second side 34b, the first or engaging edge 34c and a second edge 34d. The blade 34 also comprises a first end 34e, second end 34f, third end 34g and fourth end 34h. As best illustrated in FIG. 1, the engaging edge 34c engages the surface 14a of cylinder 14 during operation of the press 12.

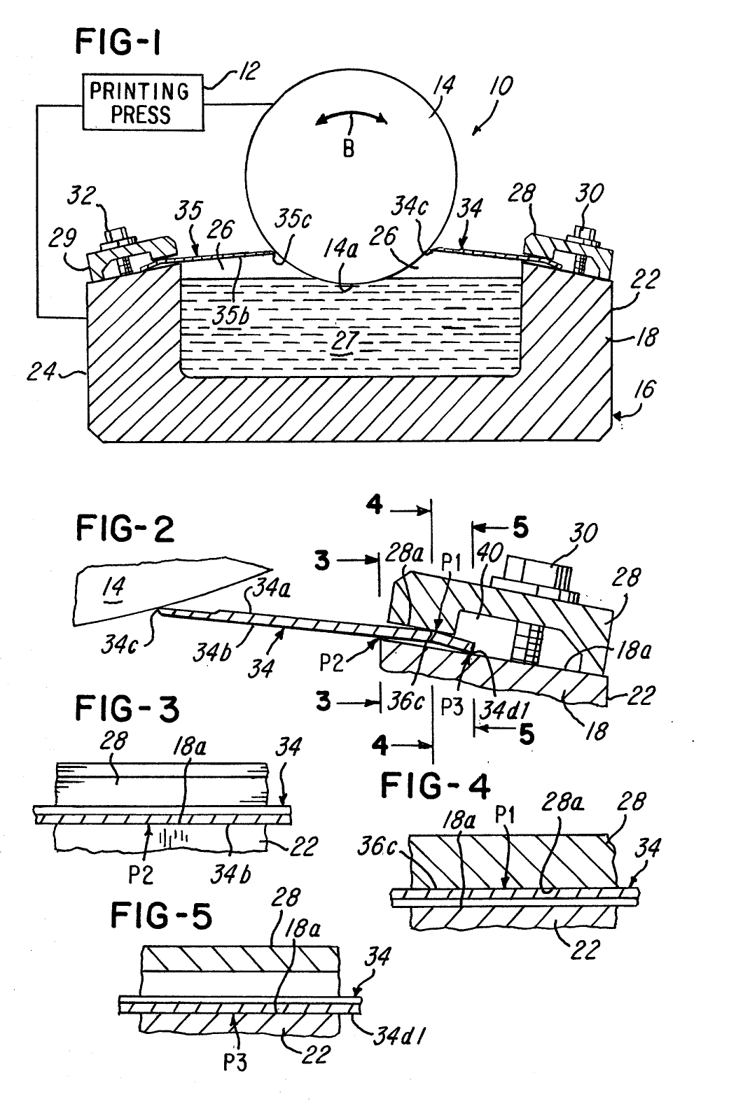

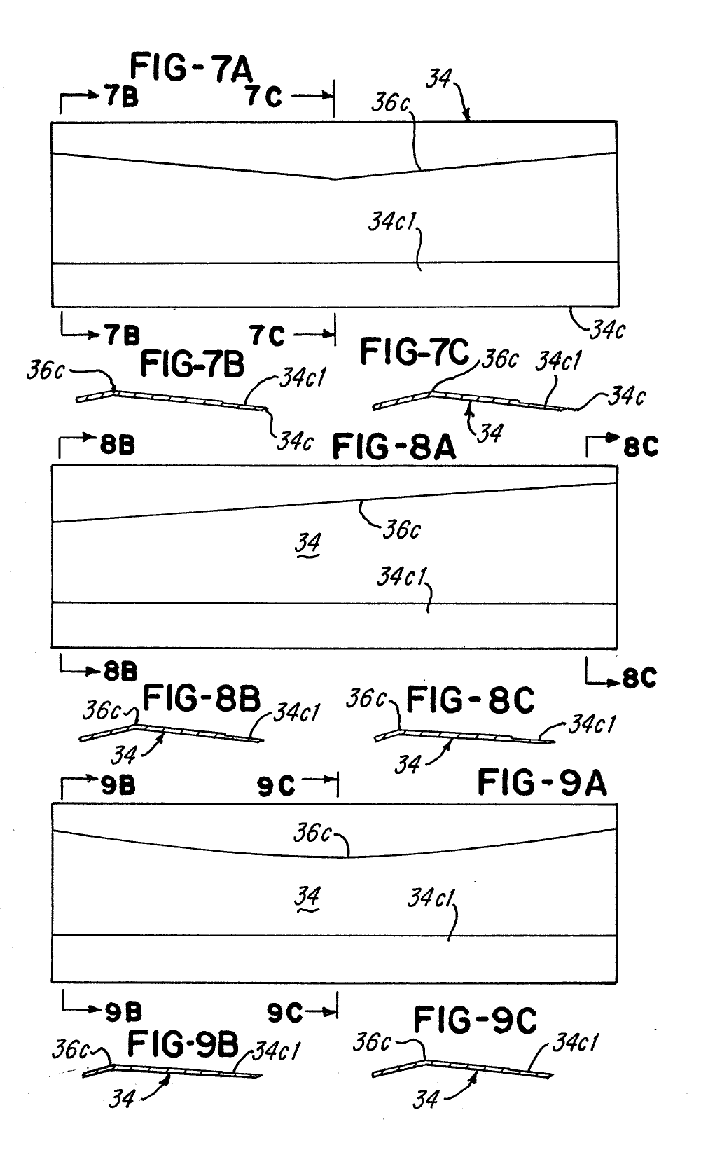

As illustrated in FIGS. 2 and 6, note that the blade 34 comprises a non-planar area 36 that is V-shaped in cross-section and is defined by a first planar portion 36a and a second planar portion 36b which are joined by a substantially continuous contacting or joining edge or portion 36c. Although the illustration is being described as showing a generally or substantially V-shaped cross-section, it should be appreciated that the shape may be any suitable shape (such as U-shaped, curved, angled or one of the shapes shown in FIGS. 7A-9C) which is capable of performing the function described herein. Note that the first portion 36a and second portion 36b cooperate to define an angle θ, which in the embodiment being described is between 1 and 90 degrees. It has been found that a predetermined angle θ of about 15 degrees is suitable in the embodiment being described. As will be described later herein, it should be appreciated that the joining portion 36c provides a substantially continuous pressure engagement edge or point of contact 36c along its length or along an entire length L of blade 34 to facilitate sealing the blade 34 and holder 16. The function and use of this contact 36c will be described later herein.

As best illustrated in FIG. 6, the edge 34c may comprise a chamfered area 34c1. Further, note that the first portion 36a comprises a first width W1 that is on the order of about ? inch. Note also that the second portion 36b comprises a width W2 that is more than W1 and is on the order of about ? inches. It should be appreciated, however, that the length L and widths W1 and W2 may change depending upon the application or the blade holder 16 in which the blade 34 is being used.

For ease of illustration, FIG. 2 shows blade 34 mounted to the first wall 22 with the nut 30 that is threadably secured through surface 18a and into wall 22. It should be appreciated that the mounting of the blade 35 onto second wall 24 is performed in the same manner.

Referring to FIG. 2, note that the blade 34 is situated between the surface 18a of wall 18 and surface 28a of jaw 28 and then the nut 30 is threadably tightened to secure the blade 34 between the surface 18a and 28a. Note that the portion 36c engages the surface 28a to provide a seal to facilitate preventing ink 27 from flowing past the intersection of the portion 36c and surface 28a and into the area 40. It should be appreciated that the blade 34 is made of resilient material, such as metal, plastic, metallic or non-metallic, so that when the nut 30 is tightened, a plurality of continuous pressure contact P1, P2 and P3 are created. This facilitates reducing or eliminating, for example, any leakage of ink 27 from the fluid area 26 (FIG. 1), past the continuous contact 36c, and into the area 40 (FIG. 2). Note that at the point P1, a continuous contact is created between the portion 36c and the surface 28a. The continuous contact point P2 is created between the surface 34b and a corner 18b of wall 18. The continuous pressure point P3 is created by the engagement of end 34d or corner 34d1 and surface 18a. Thus, it should be appreciated that these points P1, P2 and P3 facilitate preventing ink from passing. It should be appreciated that the nuts 30 and 32 may be adjustably tightened to provide various and different pressures at points P1-P3, depending on the viscosity of the fluid, resiliency of the blade 34 and the like. The pressure points P1-P3 may traverse a substantial or even entire length L of blade 34.

FIG. 4 illustrates the continuous intersection and contact point P1 created between the portion 36c and surface 28a, FIG. 3 illustrates the continuous pressure point P2 created between surface 34b and surface 18a, while FIG. 5 illustrates the continuous contact point P3 created by the contact or intersection between the edge 34d1 and the surface 18a.

During operation, the cylinder 14 is rotated about its axis (in a direction indicated by double arrow B in FIG. 1) in the printing press 12 and the surface 14a picks up ink from the area 26. For purposes of the illustration, it will be assumed that the cylinder 14 is being rotated in a clockwise (as viewed in FIG. 1) direction. As the cylinder 14 rotates, the edge 34c of blade 34 meters ink 27 from the surface 14a. This causes the ink 27 to run across the chamfer area 34c1 (FIG. 6) and over surface 36b until it engages the pressure point P1 (FIG. 2). The pressure point P1 facilitates preventing the ink 27 from flowing into the area 40 (FIG. 2), thereby providing a seal so that the ink 27 does not leak out of the blade holder 16. The ink 27 is directed back into the wall through one or more holes (not shown) in blade 34 and back into the area 26 (FIG. 1).

Ink 27 may also flow along the surface 34b until in engages the pressure point P2, which facilitates preventing the ink from flowing out of the area 36. Should any excess ink 27 flow past the continuous pressure point P2, then the continuous pressure point P3 will further facilitate preventing ink 27 from flowing out of the blade holder 16.

Note that as to blade 35, a substantial amount of excess ink will run along 35b (FIG. 1) to meter ink from the surface 14a. The blade 35 will function in the same manner as blade 34 to seal the blade 35 in the holder 16.

Advantageously, this invention provides means for sealing one or both sides of a blade, such as blades 34 and 35, to facilitate preventing undesired ink leakage. It should be appreciated that it is contemplated that this invention can be used with presses that use a single blade.

It should be appreciated that the blades 34 and 35 may be molded, stamped, formed or the like, depending on the material used to make the blades 34 and 35. For a metal blade, for example, the blades may be integrally manufactured with the cross-sectional shape shown in FIG. 6 or formed to that shape during a stamping or press operation. Moreover, the embodiment being described and shown is substantially linear contacting edge or point 36c, but it is contemplated that this edge 36c and cross-sectional shape may be any suitable shape capable of performing the sealing function. FIGS. 7A-7C, 8A-8C and 9A-9C illustrate three other contemplated non-linear shapes that may be selected to facilitate directing the ink 27 or fluid to flow in a desired manner.

While the systems and methods herein described, and the forms of apparatus for carrying these systems and methods into effect, constitute preferred embodiments of this invention, it is to be understood that the invention is not limited to these precise methods and forms of apparatus, and that changes may be made in either without departing from the scope of the invention, which is defined in the appended claims.

What is claimed is:

1. A doctor blade comprising:
a blade member;
said blade member comprising a substantially continuous pressure contact integral with the blade member to provide an ink seal when said blade is situated in a blade holder.

2. The doctor blade as recited in claim 1 wherein said substantially continuous pressure contact comprises a first portion, a second portion and an intermediate portion between said first and second portions, said first portion lying in a first plane and said second portion lying in a second plane; said first plane being substantially different from said second plane and said intermediate portion defining said substantially continuous contact.

3. The doctor blade as recited in claim 1 wherein said first portion and said second portion cooperate to define a predetermined angle.

4. The doctor blade as recited in claim 3 wherein said predetermined angle is between 1 and 90 degrees.

5. The doctor blade as recited in claim 3 wherein said predetermined angle is at least 15 degrees.

6. The doctor blade as recited in claim 1 wherein said doctor blade comprises either steel or composite material.

7. The doctor blade as recited in claim 5 wherein said doctor blade comprises either steel or composite material.

8. The doctor blade as recited in claim 1 wherein said substantially continuous pressure contact traverses an entire width of said doctor blade.

9. The doctor blade as recited in claim 8 wherein said substantially continuous pressure contact is substantially straight.

10. The doctor blade as recited in claim 1 wherein said substantially continuous pressure contact is substantially straight.

11. The doctor blade as recited in claim 1 wherein said substantially continuous pressure contact causes said doctor blade to define a plurality of substantially continuous pressure areas when said doctor blade is situated in said blade holder.

12. The doctor blade as recited in claim 11 wherein said plurality of substantially continuous pressure areas defines a first pressure area on a first side of said doctor blade and a second pressure area on a second side of said doctor blade.

13. The doctor blade as recited in claim 12 wherein said plurality of substantially continuous pressure areas defines a third pressure area on said second side of said doctor blade.

14. A doctor blade comprising:
a blade member having a first side, a second side, and a non-planar area; and
said non-planar area defining at least one contact on said first side so that when said doctor blade is situated in a blade holder in a press, said at least one contact is integral with said blade member and is in substantially continuous pressure engagement with said blade holder to facilitate preventing ink from leaking past at least one of said first side or second side of said blade holder.

15. The doctor blade as recited in claim 14 wherein said non-planar area is curved in cross-section.

16. The doctor blade as recited in claim 14 wherein said non-planar area defines at least one predetermined angle in cross-section.

17. The doctor blade as recited in claim 16 wherein said at least one predetermined angle is between 0 and 90 degrees.

18. The doctor blade as recited in claim 16 wherein said at least one predetermined angle is 15 degrees.

19. The doctor blade as recited in claim 14 wherein said substantially continuous pressure engagement traverses an entire width of said doctor blade.

20. The doctor blade as recited in claim 19 wherein said substantially continuous pressure engagement is substantially straight.

21. The doctor blade as recited in claim 14 wherein said substantially continuous pressure engagement is substantially straight.

22. The doctor blade as recited in claim 14 wherein said substantially continuous pressure engagement causes said doctor blade to define a plurality of substantially continuous pressure contacts between said doctor blade and said blade holder.

23. The doctor blade as recited in claim 22 wherein said plurality of substantially continuous pressure contacts define a first pressure area on a first side of said doctor blade and a second pressure area on a second side of said doctor blade.

24. The doctor blade as recited in claim 23 wherein said plurality of substantially continuous pressure contacts define a third pressure area on one of said first side or said second side of said doctor blade.

25. The doctor blade as recited in claim 14 wherein said blade member is V-shaped in cross-section with said blade member comprising a first planar portion and a second planar portion.

26. The doctor blade as recited in claim 14 wherein said blade member comprises a first planar portion defining a first width and a second planar portion defining a second width, said first and second widths being different.

27. The doctor blade as recited in claim 26 wherein said first width is greater than said second width and a majority of said first planar portion extends out of said blade holder while said entire second planar portion is situated in said blade holder.

28. The doctor blade as recited in claim 25 wherein said V-shape causes a plurality of continuous pressure contacts between said blade member and said blade holder.

29. The doctor blade as recited in claim 28 wherein a first one of said plurality of continuous pressure contacts occurs between said first side and said blade holder and a second one of said plurality of continuous pressure contacts occurs between said second side and said blade holder.

30. The doctor blade as recited in claim 29 wherein said first one of said plurality of continuous pressure contacts occurs between said first side and a first blade holder jaw of said blade holder.

31. The doctor blade as recited in claim 29 wherein said second one of said plurality of continuous pressure contacts occurs between said second side and a blade holder edge of said blade holder.

32. The doctor blade as recited in claim 31 wherein said first one of said plurality of continuous pressure contacts occurs between said first side and a first blade holder jaw of said blade holder.

33. The doctor blade as recited in claim 14 wherein said at least one contact is non-linear.

34. The doctor blade as recited in claim 33 wherein said at least one contact is curved.

35. The doctor blade as recited in claim 33 wherein said at least one contact is V-shaped.

36. The doctor blade as recited in claim 33 wherein said at least one contact is angled relative to an engaging edge of said blade.

37. The doctor blade as recited in claim 14 wherein said at least one contact is non-linear along a length of the blade member.

38. The doctor blade as recited in claim 37 wherein said at least one contact is angled, U-shaped or V-shaped.

39. A doctor blade assembly comprising:
a blade holder for holding a doctor blade;
at least one doctor blade situated in said blade holder; said at least one blade comprising a blade member having a first side, a second side, and a non-planar area; and
said non-planar area defining at least one contact on said first side so that when said doctor blade is situated in a blade holder in a press, said at least one contact is in substantially continuous pressure engagement with said blade holder to facilitate preventing ink from leaking past at least one of said first side or second side of said blade holder.

40. The doctor blade assembly as recited in claim 39 wherein said non-planar area is curved in cross-section.

41. The doctor blade assembly as recited in claim 39 wherein said non-planar area defines at least one predetermined angle in cross-section.

42. The doctor blade assembly as recited in claim 41 wherein said at least one predetermined angle is between 0 and 90 degrees.

43. The doctor blade assembly as recited in claim 41 wherein said at least one predetermined angle is 15 degrees.

44. The doctor blade assembly as recited in claim 39 wherein said substantially continuous pressure engagement traverses an entire width of said at least one doctor blade.

45. The doctor blade assembly as recited in claim 44 wherein said substantially continuous pressure engagement is substantially straight.

46. The doctor blade assembly as recited in claim 39 wherein said substantially continuous pressure engagement is substantially straight.

47. The doctor blade assembly as recited in claim 39 wherein said at least one doctor blade is formed to define a plurality of substantially continuous pressure contacts between said at least one doctor blade and said blade holder.

48. The doctor blade assembly as recited in claim 47 wherein said plurality of substantially continuous pressure contacts define a first pressure area on a first side of said at least one doctor blade and a second pressure area on a second side of said at least one doctor blade.

49. The doctor blade assembly as recited in claim 48 wherein said plurality of substantially continuous pressure contacts define a third pressure area on one of said first side or said second side of said at least one doctor blade.

50. The doctor blade assembly as recited in claim 48 wherein said plurality of substantially continuous pressure contacts are continuous throughout a width of said at least one doctor blade.

51. The doctor blade assembly as recited in claim 39 wherein said blade member is V-shaped in cross-section with said blade member comprising a first planar portion and a second planar portion.

52. The doctor blade assembly as recited in claim 39 wherein said blade member comprises a first planar portion defining a first width and a second planar portion defining a second width, said first and second widths being different.

53. The doctor blade assembly as recited in claim 52 wherein said first width is greater than said second width and a majority of said first planar portion extends out of said blade holder while said entire second planar portion is situated in said blade holder.

54. The doctor blade assembly as recited in claim 51 wherein said V-shape causes a plurality of continuous pressure contacts on said first side and said second side of said blade member when said blade member is situated in said blade holder.

55. The doctor blade assembly as recited in claim 51 wherein said doctor blade assembly comprises two substantially opposed doctor blades.

56. A doctor blade comprising;
a blade member comprising an engaging edge for engaging a rotating cylinder and a second edge for receipt in a blade holder;
a formed area between said first edge and said second edge;
said formed area providing a plurality of continuous pressure contacts between said blade member and said blade holder.

57. The doctor blade as recited in claim 56 wherein a first of said plurality of continuous pressure contacts is situated on a first side and a second of said plurality of continuous pressure contacts is situated on a second side of said plurality of continuous pressure contacts.

58. The doctor blade as recited in claim 57 wherein said formed area defines a V-shape area defined by a first leg portion, a connecting portion and a second leg portion, said connecting portion first of said plurality of continuous pressure contacts is defines a continuous and substantially linear sealing contact along a width of said blade member.

59. The doctor blade as recited in claim 57 wherein said first leg portion comprises said engaging edge and said second leg portion comprises said second edge.

60. The doctor blade as recited in claim 56 wherein said formed area provides a first of said plurality of continuous pressure contacts on a first side of said blade member and a second of said plurality of continuous contacts on a second side of said blade member, said first and second of said plurality of continuous contacts being situated between said engaging and second edges.

61. The doctor blade as recited in claim 60 wherein said formed area causes said second side of said blade member to be resiliently biased against said blade holder to provide a second of said plurality of continuous pressure contacts along a width of said second side of said blade member.

62. The doctor blade as recited in claim 60 wherein said formed area causes said second side of said blade member to be resiliently biased against said blade holder to provide a second of said plurality of continuous pressure contacts along a width of a second side of blade member and causes said second edge of said blade member to become resiliently biased against said blade holder to provide a third of said plurality of continuous pressure contacts along said second edge of said blade member.

63. The doctor blade as recited in claim 60 wherein a first direction of force of said first of said plurality of continuous contacts is generally opposite to each of a second direction of force of said second plurality of continuous contacts and a third direction of force of said third plurality of continuous contacts.
